(19) United States
(12) Patent Application Publication
(10) Pub. No.: US 2015/0165915 A1
(43) Pub. Date: Jun. 18, 2015

(54) VEHICLE CHARGING SYSTEM

(71) Applicant: David Cun, Torrence, CA (US)

(72) Inventor: David Cun, Torrence, CA (US)

(73) Assignee: HONDA MOTOR CO., LTD., Tokyo (JP)

(21) Appl. No.: 14/107,241

(22) Filed: Dec. 16, 2013

(51) Int. Cl. B60L 11/18; H02J 7/35

(52) U.S. Cl. CPC B60L 11/1809; H02J 7/35; B60L 11/1838

(57) ABSTRACT

Provided is a method of controlling charging of a vehicle charging station supplementary energy storage system. The method includes receiving at least one of vehicle location information and vehicle charge information, regarding a vehicle in transit remote from a vehicle charging station. At the vehicle charging station, a recharging rate of the vehicle charging station supplementary energy storage system is adjusted based on the at least one of the vehicle location information and the vehicle charge information regarding the vehicle in transit remote from the vehicle charging station. The vehicle charging station supplementary energy storage system is configured to supply electrical energy for recharging a vehicle at the vehicle charging station.

### BACKGROUND

Conventional chargers for electric vehicles draw electric power from a utility grid and convert the power as needed to recharge a battery bank within an electric vehicle. Recharging the battery bank quickly can result in a substantial power demand during recharging. The utility that supplies the electric power to the charger may apply a demand charge in addition to charging a customer for the energy consumed. The demand charge is based on the peak demand (e.g., peak amount of power consumed) during a billing cycle. It can be beneficial to reduce the level of power drawn from the utility grid while recharging the battery bank of electric vehicles, to reduce potential demand charges that may be applied by the utility.

### BRIEF SUMMARY

The following summary presents a simplified summary in order to provide a basic understanding of some aspects of the devices, systems and methods discussed herein. This summary is not an extensive overview of the devices, systems and methods discussed herein. It is not intended to identify critical elements or to delineate the scope of such devices, systems and methods. Its sole purpose is to present some concepts in a simplified form as a prelude to the more detailed description that is presented later.

In accordance with one aspect, provided is a method of controlling charging of a vehicle charging station supplementary energy storage system. The method includes receiving at least one of vehicle location information and vehicle charge information, regarding a vehicle in transit remote from a vehicle charging station. At the vehicle charging station, a recharging rate of the vehicle charging station supplementary energy storage system is adjusted based on the at least one of the vehicle location information and the vehicle charge information regarding the vehicle in transit remote from the vehicle charging station. The vehicle charging station supplementary energy storage system is configured to supply electrical energy for recharging a vehicle at the vehicle charging station.

In accordance with another aspect, provided is a system for controlling power demand at vehicle charging stations. A vehicle charging station is operatively connected to a utility grid. The vehicle charging station includes a vehicle charging station supplementary energy storage system configured to store electrical energy drawn from the utility grid and to supply the electrical energy to a vehicle at the vehicle charging station to recharge the vehicle. A vehicle charging station management device is in communication with the vehicle charging station. The vehicle charging station management device includes at least one processor and a non-transitory computer readable medium comprising executable code for causing the at least one processor to receive at least one of vehicle location information and vehicle charge information regarding a vehicle in transit remote from the vehicle charging station, receive vehicle charging station charge information regarding the vehicle charging station supplementary energy storage system, and generate an instruction for the vehicle charging station to adjust a recharging rate of the vehicle charging station supplementary energy storage system based on the vehicle charging station charge information and the at least one of the vehicle location information and vehicle charge information.

In accordance with another aspect, provided is a vehicle charging station for recharging an electric vehicle. A local supplementary energy storage system is configured to store electrical energy drawn from a utility grid. A vehicle charger is operatively connected to both of the local supplementary energy storage system and the utility grid, and is configured to recharge the electric vehicle using at least one of the electrical energy stored in the local supplementary energy storage system and electrical energy drawn from the utility grid. When the electric vehicle is in transit remote from the vehicle charging station, the vehicle charging station adjusts a recharging rate of the local supplementary energy storage system by the electrical energy drawn from the utility grid, based on at least one of vehicle location information and vehicle charge information regarding the electric vehicle.

### BRIEF DESCRIPTION OF THE DRAWINGS

FIG. 1 is a schematic block diagram of an example system for controlling power demand at vehicle charging stations; and

FIG. 2 is a schematic diagram of an example vehicle charging station; and

FIG. 3 is a flow diagram of a process for adjusting a recharging rate of a supplementary energy storage system at a vehicle charging station.

### DETAILED DESCRIPTION

Example embodiments that incorporate one or more aspects of the present disclosure are described and illustrated in the drawings. These illustrated examples are not intended to be a limitation on the present disclosure. For example, one or more aspects of the present disclosure can be utilized in other embodiments and even other types of devices. Moreover, certain terminology is used herein for convenience only and is not to be taken as a limitation. Still further, in the drawings, the same reference numerals are employed for designating the same elements.

As used herein, the terms “electric vehicle” refer to rechargeable vehicles with or without internal combustion engines, and include rechargeable hybrid vehicles.

Some customers of electric utilities, in particular large users of electricity such as commercial or industrial customers, may be subject to demand charges by the utility. The demand charges are calculated from the peak electrical power demand (kW) of the customer during a billing cycle. For example, a customer may be subject to a demand charge of $11/kW in addition to being charged for the electricity actually consumed (kW·hr) during the billing cycle.

As recharging rates for electric vehicles improve, allowing electric vehicles to be charged more quickly, the electricity demand during recharging increases. For example, the electricity demand of some electric vehicles during recharging can reach 90 kW or more (e.g., 120 kW). For a charging station that recharges electric vehicles, fast recharging rates can lead to demand charges of hundreds or thousands of dollars. To reduce the peak demand from the utility grid, charging stations can add alternate sources of power, such as a backup generator, a photovoltaic system, wind turbines, etc., along with a supplementary energy storage system. The supplementary energy storage system would typically be a battery bank, but could also include other types of energy storage systems, such as capacitor storage systems. Photovoltaic systems and wind turbines are examples of renewable energy sources that can be used to provide supplemental power to vehicle charging stations.

A supplementary energy storage system at a vehicle charging station can be slowly charged over time by power from the utility and/or a renewable energy source. The supplementary energy storage system can then be discharged quickly when recharging a vehicle, to reduce the power demand from the utility (and potentially reduce peak demand charges). However, if a vehicle arrives at the charging station and the State of Charge (SOC) of the supplementary energy storage system is low, the storage system's ability to reduce the power demand from the utility during recharging is diminished.

Described below are methods, systems and devices for automatically adjusting the recharging rate of a supplementary energy storage system in anticipation of a vehicle arriving at the charging station. Based on the vehicle's proximity and/or its SOC, the charging station can increase the recharging rate of the supplementary energy storage system (e.g., by increasing the electrical power drawn from the utility). The charging station's electrical power demand from the utility upon increasing the recharging rate of the supplementary energy storage system, is less than the electrical power demand by the vehicle (e.g., by the vehicle's battery bank) during its recharging at the charging station. Thus, by anticipating the arrival of the vehicle at the charging station and preemptively increasing the recharging rate of the supplementary energy storage system, peak demand during vehicle recharging, and the associated demand charges, may be reduced.

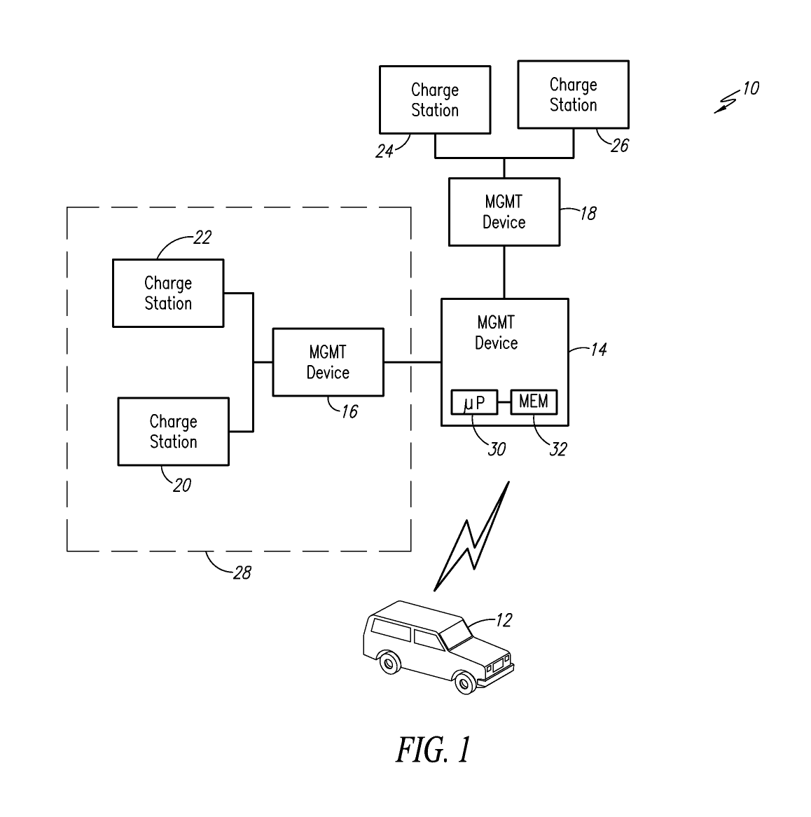

FIG. 1 is a schematic block diagram of an example system 10 for controlling power demand at vehicle charging stations. An electric vehicle 12 employs a telematics system and wirelessly communicates information to a remote vehicle charging station management device 14. The vehicle 12 can include a global positioning system (GPS) receiver and can transmit operational data, including current position, to the vehicle charging station management device 14. For example, through its telematics system, the vehicle 12 can transmit operational data such as speed, location, energy consumption rate, battery size, SOC, etc. The vehicle's telematics system can communicate with the vehicle charging station management device 14 using a transceiver that is dedicated to the telematics system. Alternatively, the telematics system can utilize a driver's cellular telephone, such as through a Bluetooth connection to the telephone, to communicate with the vehicle charging station management device 14.

In FIG. 1, the vehicle charging station management device 14 that communicates with the electric vehicle 12 also communicates with other vehicle charging station management devices 16, 18. In certain embodiments, some vehicle charging station management devices 16, 18 can communicate with both vehicle charging stations 20, 22, 24, 26 and other vehicle charging station management devices 14, while some vehicle charging station management devices 14 only communicate with other vehicle charging station management devices 16, 18 and electric vehicles 12. In certain embodiments, the electric vehicle 12 can communicate with any vehicle charging station management device 14, 16, 18, while in other embodiments, the vehicle 12 only communicates with a primary vehicle charging station management device 14, which itself communicates with the other vehicle charging station management devices 16, 18. In an embodiment in which the vehicle 12 only communicates with a primary vehicle charging station management device 14, the primary vehicle charging station management device can be configured as a central server that exchanges data, instructions, etc., with the other vehicle charging station management devices 16, 18.

One or more vehicle charging stations 20, 22, and a vehicle charging station management device 16 in communication with the vehicle charging stations, can form a charger area network 28. The vehicle charging station management device 16 can bidirectionally communicate with the vehicle charging stations 20, 22 in the charger area network, and can control various operations occurring at the vehicle charging stations. The vehicle charging station management device 16 can be located remotely from each of the vehicle charging stations 20, 22 within the charger area network 28, or it can be located at one of the charging stations. Alternatively, the vehicle charging station management device can be distributed among plural charging stations 20, 22. In such a configuration, the plural charging stations 20, 22 can each have a processor that can perform some or all of the functions of the vehicle charging station management device 16, and together the separate processors can be considered as the vehicle charging station management device in a charger area network 28.

The vehicle charging station management devices 14, 16, 18 can include one or more electronic controllers, such as one or more processors 30. The vehicle charging station management devices 14, 16, 18 can include one or more of a microprocessor, a microcontroller, a digital signal processor (DSP), an application specific integrated circuit (ASIC), a field-programmable gate array (FPGA), discrete logic circuitry, or the like. The vehicle charging station management devices can include a memory portion or a non-transitory computer readable medium 32 (e.g., RAM or ROM) storing program instructions (e.g., executable code) that cause the processor 30 to provide the functionality ascribed to it herein.

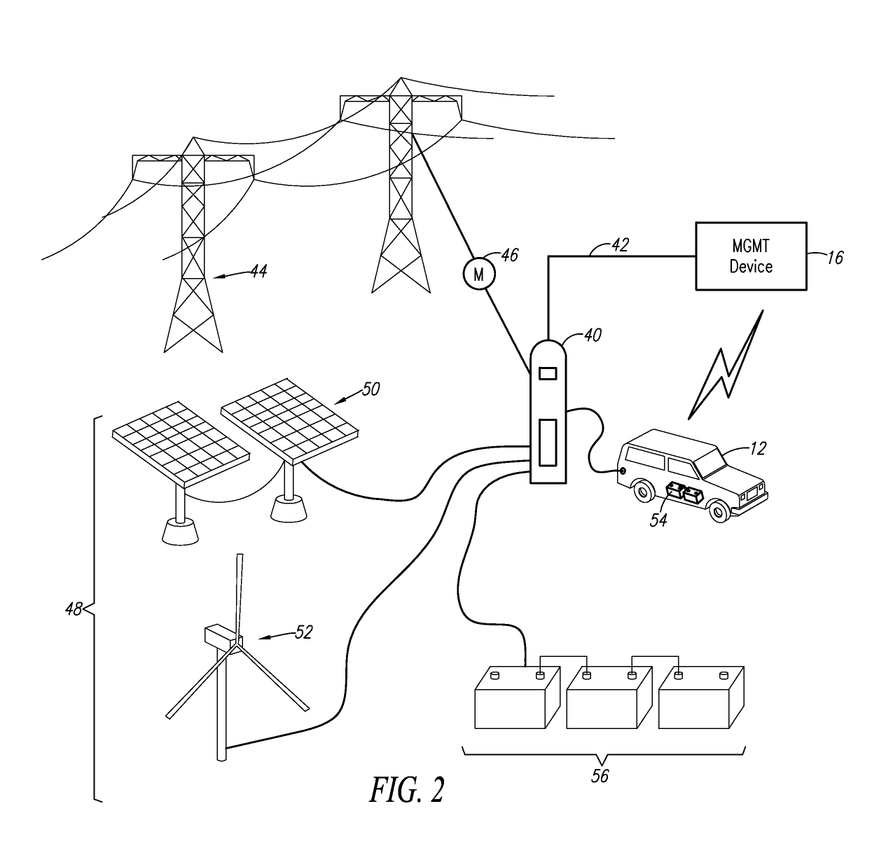

FIG. 2 shows details of an example vehicle charging station 20. The vehicle charging station recharges the electric vehicle 12, which is connected to a charger 40. The charger 40 is operatively connected to one or more vehicle charging station management devices 16. The charger 40 and vehicle charging station management device 16 can be part of a charger area network, and can bidirectionally communicate with each other via a wired or wireless communication link 42.

The vehicle charging station 20 is connected to the utility grid 44 to receive commercial electric power from the grid. The electric power consumed from the utility grid 44 is metered through an electric meter 46, which can record both energy consumption and peak demand. The vehicle charging station can also be connected to renewable energy sources 48, such as a photovoltaic system 50, one or more wind turbines 52, or other renewable energy sources. Electrical energy for recharging a vehicle battery bank 54 within the vehicle 12 is provided to the charger 40 from either one, or simultaneously from both of, the utility grid 44 and a renewable energy source 48. The vehicle charging station 20 further includes a supplementary energy storage system 56, such as battery bank. The supplementary energy storage system is typically located at the vehicle charging station 20. The supplementary energy storage system 56 can be charged or recharged by electrical energy supplied by either one, or simultaneously from both of, the utility grid 44 and a renewable energy source 48. Appropriate charging control circuitry at the vehicle charging station 20 can control the recharging of the supplementary energy storage system 56 (e.g., control recharging rate, recharging level, current, voltage, etc.) The recharging of the supplementary energy storage system 56 can be controlled based on instructions or commands from the vehicle charging station management device 16, as will be described below.

The supplementary energy storage system 56 can provide a “peak shaving” function when a vehicle battery bank is recharged, to reduce the peak power demand from the utility grid 44 when a vehicle is recharged. The charging station 20 can be configured to discharge the supplementary energy storage system 56 more quickly than it charges the supplementary energy storage system, when recharging a vehicle, to accommodate a large power demand (e.g., 90 kW, 120 kW, more than 120 kW, etc.) when recharging the vehicle. By recharging the supplementary energy storage system 56 more slowly than it discharges the supplementary energy storage system, the charging station 20 can supply a larger peak power demand to the vehicle than it draws from the utility grid 44. Power for recharging the vehicle can be provided by any of the utility grid 44, the renewable energy sources 48, and the supplementary energy storage system 56 simultaneously.

Returning to FIG. 1, when the electric vehicle 12 is in transit remote from a vehicle charging station 20, 22, 24, 26 (e.g., not stopped at a vehicle charging station), it can periodically communicate with a vehicle charging station management device 14, 16, 18. The electric vehicle 12 can communicate with the vehicle charging station management device 14, 16, 18 at regular intervals, or based on the vehicle entering a predetermined geographical area. For example, the electric vehicle 12 can communicate with the vehicle charging station management device 14, 16, 18 when the vehicle enters the geographical area of a charger area network, or is a predetermined distance (e.g., a predetermined radius) from a charging station 20, 22, 24, 26.

The vehicle charging station management device 14, 16, 18 receives vehicle location information (e.g., position, speed, etc.) and vehicle charge information (e.g., energy consumption rate, battery size, SOC, etc.) from the electric vehicle's telematics system. The vehicle charging station management device 14, 16, 18 can receive the vehicle location information and the vehicle charge information directly from the vehicle 12, or from another vehicle charging station management device. Based on the vehicle location information and vehicle charge information, the vehicle charging station management device 14, 16, 18 can predict at least one of the plurality of vehicle charging stations 20, 22, 24, 26 as a destination of the vehicle 12 in transit. That is, the vehicle charging station management device 14, 16, 18 can predict one or more of the vehicle charging stations 20, 22, 24, 26 at which the electric vehicle is likely to stop, so that the vehicle can be recharged. This information can be communicated to the predicted vehicle charging station, other vehicle charging stations, other vehicle charging station management devices, and/or to the vehicle 12.

If, for example, the vehicle 12 in transit is traveling east at a given speed and is consuming energy at a given rate, the vehicle charging station management device 14, 16, 18 can determine from such information which vehicle charging station(s) 20, 22, 24, 26 along the vehicle's easterly route are likely destination charging stations. The vehicle charging station management device 14, 16, 18 can then communicate with the likely destination vehicle charging station(s) to inform them that a vehicle is approaching, its expected arrival time, its battery size, its power demand when recharging, etc. This information can be communicated to the appropriate vehicle charging station(s) directly, or through intermediary vehicle charging station management devices. For example, in a central server configuration in which the vehicle 12 in transit only communicates with a primary vehicle charging station management device 14, the primary vehicle charging station management device can provide information about an approaching vehicle to another vehicle charging station management device 16, 18 in a particular charger area network in which the vehicle has or is about to enter. A primary vehicle charging station management device 14 could also communicate with individual vehicle charging stations 20, 22, 24, 26 directly. Any of the primary vehicle charging station management device 14, another vehicle charging station management device 16, 18, and even individual vehicle charging stations 20, 22, 24, 26 can be configured to predict the likely destination of the vehicle 12 and how to respond to its impending recharging requirements.

After predicting which vehicle charging station(s) 20, 22, 24, 26 the vehicle is likely to stop at for recharging (referred to as “destination vehicle charging station” or “destination charging station”), or after receiving such information from another vehicle charging station management device, the vehicle charging station management device 14, 16, 18 can communicate with the destination charging station to obtain information about the present conditions at the destination charging station. For example, the vehicle charging station management device 14, 16, 18 can receive information about the SOC and current recharging rate of the supplementary energy storage system 56 (FIG. 2) at the destination vehicle charging station whether there is a utility outage at the destination charging station, the current rate of energy generation by the renewable energy sources 48 (if present), etc.

Based on the vehicle location information, the vehicle charge information and the current conditions at the destination charging station (e.g., the SOC of the supplementary energy storage system 56), the vehicle charging station management device 14, 16, 18 can calculate a recharging rate increase for the supplementary energy storage system 56 and instruct the destination charging station to adjust the recharging rate of the supplementary energy storage system 56 accordingly, or instruct the destination charging station to maintain the current recharging rate or take no action in anticipation of the vehicle's arrival. By analyzing the current rate of energy generation by the renewable energy sources 48, the vehicle charging station management device 14, 16, 18 can instruct the destination charging station to adjust (e.g., increase) the recharging rate of the supplementary energy storage system 56 using energy supplied by the renewable energy sources or using energy drawn from the utility grid 44. As discussed above, the supplementary energy storage system 56 can provide a “peak shaving” function when the vehicle 12 is recharged, to reduce the peak power demand from the utility grid 44. The charging station 20 can be configured to discharge the supplementary energy storage system 56, during vehicle recharging, more quickly than it charges the supplementary energy storage system, to accommodate the large power demand when recharging the vehicle 12 while mitigating utility demand charges. If the SOC of the supplementary energy storage system 56 at the destination charging station is too low, the vehicle charging station management device 14, 16, 18 can instruct the destination charging station to increase the recharging rate of the supplementary energy storage system in anticipation of the vehicle's arrival at the destination charging station. The amount of the increase to the recharging rate of the supplementary energy storage system 56 can be based on the vehicle location information, the vehicle charge information and/or the SOC of the supplementary energy storage system. The decision to increase the recharging rate of the supplementary energy storage system 56, and the degree to which the recharging rate in increased, is made automatically prior to adjusting the recharging rate, and can be made by either the vehicle charging station management device 14, 16, 18 or the destination charging station.

If the recharging rate of the supplementary energy storage system 56 is increased with sufficient advanced warning of the arrival of the vehicle 12 to be recharged, the electrical power demand by the local battery bank in the supplementary energy storage system during its recharging can be less than the electrical power demand by the vehicle. Thus, even though the power demand of the supplementary energy storage system 56 is intentionally increased, such increased power demand can still be less than the power demand of the vehicle 12 during recharging, which may mitigate demand charges imposed by the utility.

In an example embodiment, the supplementary energy storage system 56 can, under normal conditions, be recharged by power supplied by the renewable energy sources 48. However, when an impending vehicle arrival is predicted, the recharging rate of the supplementary energy storage system 56 can be increased by drawing power from the utility grid 44. Immediately prior to adjusting the recharging rate of the supplementary energy storage system 56, the supplementary energy storage system is recharged by power supplied by the renewable energy sources 48. Immediately subsequent to adjusting the recharging rate of the supplementary energy storage system 56, the supplementary energy storage system is recharged by power supplied by the utility, and possibly also the renewable energy sources.

Under certain conditions, it might be more likely that the recharging rate of the supplementary energy storage system 56 would be increased in anticipation of a vehicle's arrival. For example, during the late afternoon on a sunny day, the supplementary energy storage system 56 might be fully charged by a photovoltaic system 50 at the destination charging station. However, in the morning, the local battery bank in the supplementary energy storage system 56 might be substantially discharged (low SOC), rendering the supplementary energy storage system ineffective in reducing power demand during vehicle recharging. In this case, it can be desirable to preemptively increase the recharging rate of the supplementary energy storage system 56 as needed, by drawing power from the utility grid 44, in anticipation of an expected vehicle arrival, in order to mitigate demand charges.

As discussed above, the electric vehicle 12 can communicate with the vehicle charging station management device periodically or based on the vehicle entering a predetermined geographical area. In either case, the current position of the vehicle can trigger an adjustment of the recharging rate of the supplementary energy storage system 56 as described herein.

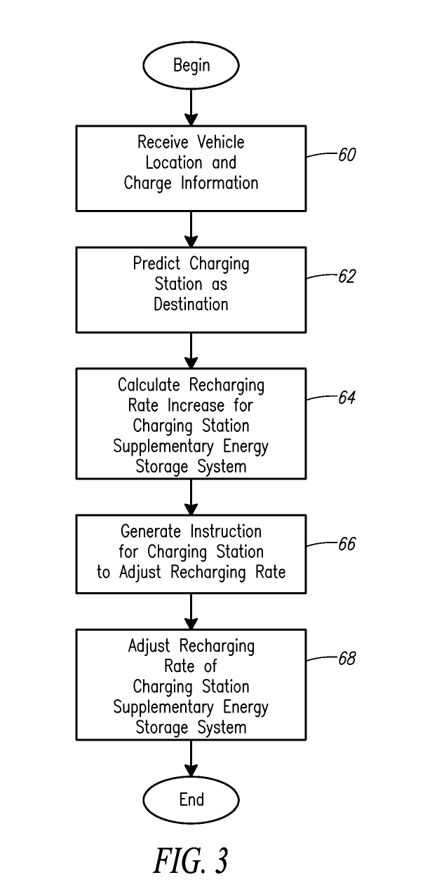

FIG. 3 is a flow diagram of a process for adjusting the recharging rate of a supplementary energy storage system 56 at a vehicle charging station 20. In step 60 at least one of vehicle location information and vehicle charge information regarding a vehicle in transit remote from a vehicle charging station is receive by one or more vehicle charging station management devices or vehicle charging stations. In step 62, at least one charging station is predicted as a destination of the vehicle in transit, based on the vehicle location information and/or the vehicle charge information. In step 64, a recharging rate increase for a vehicle charging station supplementary energy storage system is calculated prior to adjusting the recharging rage, based on the vehicle location information and/or the vehicle charge information. In step 66, an instruction for a vehicle charging station to adjust the recharging rate of the supplementary energy storage system is generated (e.g., by a vehicle charging station management device) based on charge information from the charging station and one or both of the vehicle location information and the vehicle charge information. In step 68, the recharging rate of the vehicle charging station supplementary energy storage system is adjusted based on the vehicle location information and/or the vehicle charge information regarding the vehicle in transit remote from the vehicle charging station.

The disclosure has been described with reference to the example embodiments described above. Modifications and alterations will occur to others upon a reading and understanding of this specification. Example embodiments incorporating one or more aspects are intended to include all such modifications and alterations insofar as they come within the scope of the appended claims.

What is claimed is:

1. A method of controlling charging of a vehicle charging station supplementary energy storage system, comprising:
receiving at least one of vehicle location information and vehicle charge information, regarding a vehicle in transit remote from a vehicle charging station;
adjusting, at the vehicle charging station, a recharging rate of the vehicle charging station supplementary energy storage system based on the at least one of the vehicle location information and the vehicle charge information regarding the vehicle in transit remote from the vehicle charging station,
wherein the vehicle charging station supplementary energy storage system is configured to supply electrical energy for recharging a vehicle at the vehicle charging station.

2. The method of claim 1, wherein adjusting the recharging rate of the vehicle charging station supplementary energy storage system includes increasing electrical power drawn from a utility grid to increase the recharging rate of the vehicle charging station supplementary energy storage system.

3. The method of claim 2, wherein immediately prior to adjusting the recharging rate of the vehicle charging station supplementary energy storage system, the vehicle charging station supplementary energy storage system is recharged by electrical power supplied by a renewable energy source, and immediately subsequent to adjusting the recharging rate of the vehicle charging station supplementary energy storage system, the vehicle charging station supplementary energy storage system is recharged by electrical power simultaneously supplied by both of the renewable energy source and a utility grid.

4. The method of claim 3, wherein the renewable energy source includes at least one of a photovoltaic system and a wind turbine.

5. The method of claim 2, further comprising calculating a recharging rate increase for the vehicle charging station supplementary energy storage system, based on the vehicle location information and the vehicle charge information regarding the vehicle in transit remote from the vehicle charging station.

6. The method of claim 2, wherein the vehicle charging station supplementary energy storage system comprises a local battery bank configured for recharging a vehicle battery bank.

7. The method of claim 6, further comprising, subsequent to the vehicle in transit arriving at the vehicle charging station, recharging the vehicle battery bank using electrical power simultaneously drawn from the utility grid and the local battery bank,
wherein an electrical power demand (kW) by the local battery bank, upon increasing the recharging rate of the local battery due to the adjusting, is less than an electrical power demand (kW) by the vehicle battery bank during the recharging the vehicle battery bank.

8. A system for controlling power demand at vehicle charging stations, comprising:
a vehicle charging station operatively connected to a utility grid, the vehicle charging station comprising a vehicle charging station supplementary energy storage system configured to store electrical energy drawn from the utility grid and to supply the electrical energy to a vehicle at the vehicle charging station to recharge the vehicle; and
a vehicle charging station management device in communication with the vehicle charging station, the vehicle charging station management device comprising at least one processor and a non-transitory computer readable medium comprising executable code for causing the at least one processor to:
receive at least one of vehicle location information and vehicle charge information regarding a vehicle in transit remote from the vehicle charging station;
receive vehicle charging station charge information regarding the vehicle charging station supplementary energy storage system; and
generate an instruction for the vehicle charging station to adjust a recharging rate of the vehicle charging station supplementary energy storage system based on the vehicle charging station charge information and the at least one of the vehicle location information and vehicle charge information.

9. The system of claim 8, wherein the vehicle charging station management device is in communication with a plurality of vehicle charging stations, and the non-transitory computer readable medium comprises further executable code for causing the at least one processor to predict at least one of the plurality of vehicle charging stations as a destination of the vehicle in transit, based on both of the vehicle location information and vehicle charge information of the vehicle in transit.

10. The system of claim 8, wherein the at least one processor includes a processor located remote from the vehicle charging station.

11. The system of claim 8, wherein the at least one processor includes a processor located at the vehicle charging station.

12. The system of claim 8, wherein the vehicle charging station management device automatically receives the vehicle location information and vehicle charge information regarding the vehicle in transit, and generates the instruction, when the vehicle in transit enters a predetermined geographical area.

13. The system of claim 8, wherein in response to the instruction, the vehicle charging station increases electrical power drawn from the utility grid to increase the recharging rate of the vehicle charging station supplementary energy storage system, and an electrical power demand (kW) by the vehicle charging station supplementary energy storage system upon increasing the recharging rate is less than an electrical power demand (kW) of the vehicle during a recharging of the vehicle.

14. A vehicle charging station for recharging an electric vehicle, comprising:
a local supplementary energy storage system configured to store electrical energy drawn from a utility grid; and
a vehicle charger operatively connected to both of the local supplementary energy storage system and the utility grid, and configured to recharge the electric vehicle using at least one of the electrical energy stored in the local supplementary energy storage system and electrical energy drawn from the utility grid,
wherein, when the electric vehicle is in transit remote from the vehicle charging station, the vehicle charging station adjusts a recharging rate of the local supplementary energy storage system by the electrical energy drawn from the utility grid, based on at least one of vehicle location information and vehicle charge information regarding the electric vehicle.

15. The vehicle charging station of claim 14, wherein the vehicle charging station adjusts the recharging rate of the local supplementary energy storage system so as to increase the recharging rate by increasing electrical power drawn from the utility grid.

16. The vehicle charging station of claim 15, further comprising a renewable energy source operatively connected to the local supplementary energy storage system, the renewable energy source including at least one of a photovoltaic system and a wind turbine,
wherein the local supplementary energy storage system is configured to store electrical energy supplied by the renewable energy source.

17. The vehicle charging station of claim 15, wherein an electrical power demand (kW) by the local supplementary energy storage system, upon increasing the recharging rate of the local supplementary energy storage system due to the vehicle charging station adjusting the recharging rate of the local supplementary energy storage system based on the at least one of vehicle location information and vehicle charge information regarding the electric vehicle, is less than an electrical power demand (kW) by the electric vehicle during recharging of the electric vehicle.

18. The vehicle charging station of claim 14, wherein the vehicle charging station adjusts the recharging rate of the local supplementary energy storage system according to a received command that is based on the at least one of vehicle location information and vehicle charge information regarding the electric vehicle.

19. The vehicle charging station of claim 14, wherein the vehicle charging station receives the at least one of vehicle location information and vehicle charge information regarding the electric vehicle.

20. The vehicle charging station of claim 14, wherein the local supplementary energy storage system comprises a battery bank.
